(19) United States
(12) Patent Application Publication
(10) Pub. No.: US 2013/0227250 A1
(43) Pub. Date: Aug. 29, 2013

(54) SIMD ACCELERATOR FOR DATA COMPARISON

(71) Applicants: Wilhelm Haller, Remshalden (DE); Ulrich Krauch, Dettenhausen (DE); Kurt Lind, Tuebingen (DE); Friedrich Schroeder, Stuttgart (DE); Alexander Woerner, Boebingen (DE)

(72) Inventors: Wilhelm Haller, Remshalden (DE); Ulrich Krauch, Dettenhausen (DE); Kurt Lind, Tuebingen (DE); Friedrich Schroeder, Stuttgart (DE); Alexander Woerner, Boebingen (DE)

(73) Assignee: International Business Machines Corporation, Armonk, NY (US)

(21) Appl. No.: 13/405,021

(22) Filed: Feb. 24, 2012

(51) Int. Cl. G06F 9/30; G06F 9/345; G06F 9/302

(52) U.S. Cl. 712/200; 712/E09.039; 712/E09.017

(57) ABSTRACT

Some example embodiments include an apparatus for comparing a first operand to a second operand. The apparatus includes a SIMD accelerator configured to compare first multiple parts (e.g., bytes) of first operand to second multiple parts (e.g., bytes) of the second operand. The SIMD accelerator includes a ones' complement subtraction logic and a twos' complement logic configured to perform logic operations on the multiple parts of the first operand and the multiple parts of the second operand to generate a group of carry out and propagate data across bits of the multiple parts. At least a portion of the group of carry out and propagate data is reused in the group of logic operations.

### BACKGROUND

Embodiments of the inventive subject matter generally relate to the field of computers, and, more particularly, to a Single Instruction Multiple Data (SIMD) accelerator for data comparison.

The comparison to determine if two sets of data are equal is generally very intensive in terms of the amount of execution needed, especially as the size of the two sets of data increases. For example, two alphanumeric strings can be compared to determine if they are the same. Applications of such string comparisons can be a determination of whether two documents are the same, whether a certain word is located in a document, etc.

### SUMMARY

Some example embodiments include an apparatus for comparing a first operand to a second operand. The apparatus includes a SIMD accelerator configured to compare first multiple parts (e.g., bytes) of first operand to second multiple parts (e.g., bytes) of the second operand. The SIMD accelerator includes an input logic configured to input the first operand and the second operand. The SIMD accelerator includes a ones' complement subtraction logic configured to perform a first group of logic operations on the first multiple parts of the first operand and the second multiple parts of the second operand to generate a first group of carry out and propagate data across bits of the first multiple parts and the second multiple parts. The SIMD accelerator also includes a twos' complement subtraction logic configured to perform a second group of logic operations on the first multiple parts of the first operand and the second multiple parts of the second operand to determine a second group of carry out and propagate data across bits of the first multiple parts and the second multiple parts. At least a portion of the first group of carry out and propagate data is reused in the second group of logic operations, wherein at least a portion of the second group of carry out and propagate data is reused in the first group of logic operations. The SIMD accelerator includes an output logic configured to output a result to indicate whether the first operand is equal to the second operand based on the first group of logic operations and the second group of logic operations.

### BRIEF DESCRIPTION OF THE DRAWINGS

The present embodiments may be better understood, and numerous objects, features, and advantages made apparent to those skilled in the art by referencing the accompanying drawings.

FIG. 1 depicts a computer system, according to some example embodiments.

FIG. 2 depicts a more detailed diagram of logical functions of a SIMD accelerator having reuse of such functions for byte comparison of two operands, according to some example embodiments.

FIG. 3 depicts a more detailed diagram of logical functions of a SIMD accelerator having reuse of such functions for byte comparison of two operands, according to some other example embodiments.

FIG. 4 depicts a more detailed diagram of logical functions of a SIMD accelerator having reuse of such functions for comparison of operands for multiple bytes (two byte example), according to some example embodiments.

FIG. 5 depicts a more detailed block diagram of a SIMD accelerator that comprises logical function reuse, according to some example embodiments.

FIG. 6 depicts a flowchart of operations for byte comparison of two operands by a SIMD accelerator, according to some example embodiments.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. For instance, although examples refer to the data as bytes or half-words of an operand for processing by a Single Instruction Multiple Data (SIMD) accelerator, some example embodiments can process data of any size. In other instances, well-known instruction instances, protocols, structures and techniques have not been shown in detail in order not to obfuscate the description.

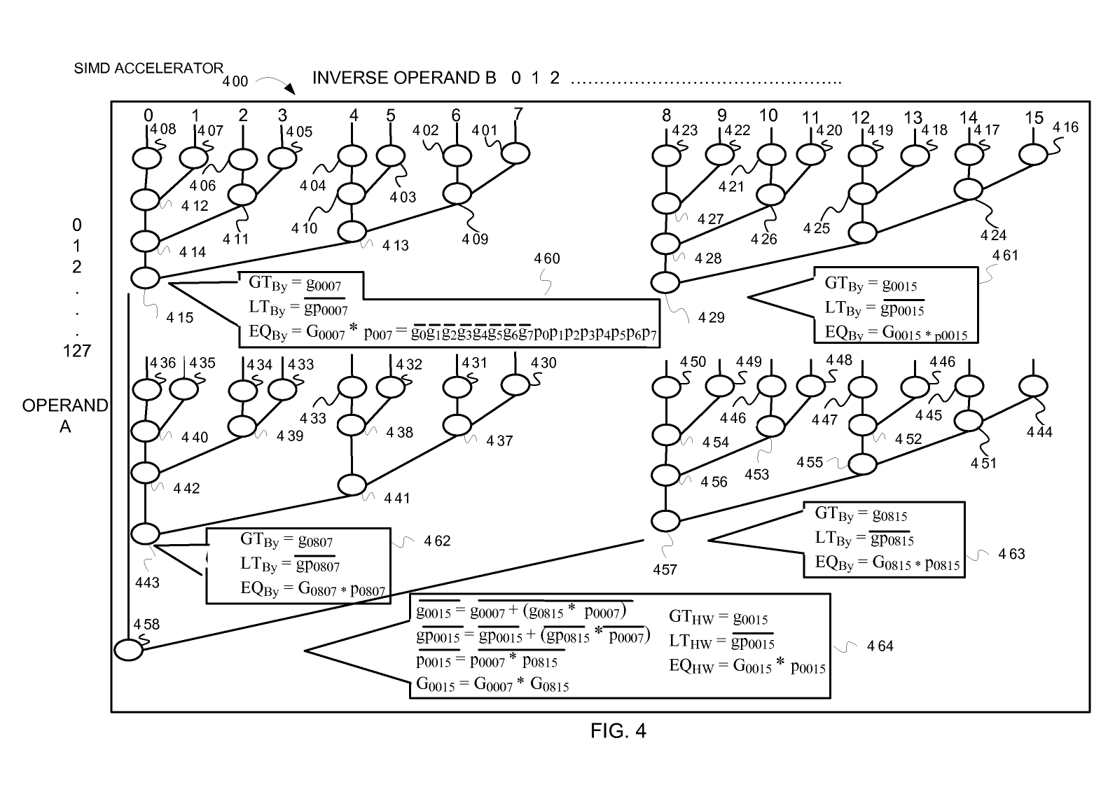

Some example embodiments use a SIMD accelerator to determine whether two sets of data (e.g., alphanumeric strings) are equal. Each set of data can be defined as an operand that is input into the SIMD accelerator. The SIMD accelerator can compare subparts of each operand to each other. For example, the operands can be comprised of multiple bytes (e.g., 16), wherein the SIMD accelerator can compare any byte of a first operand to any byte of the second operand. While described such that the SIMD accelerator performs a byte comparison, in some other example embodiments, the subparts that are compared can include half-words, words, etc. One such example wherein half-words are compared is described in reference to FIG. 4 (which is further described below).

In some example embodiments, the SIMD accelerator can determine whether a byte from a first operand (Operand A) is greater than, less than or equal to a byte from a second operand (Operand B). Similar, the SIMD accelerator can determine whether a half-word from Operand A is greater than, less than or equal to a half-word from Operand B. The SIMD accelerator can compare either aligned or unaligned half-words, words, etc. For the formulas provided herein, it is assumed that the operand B is inverted (for ease of use this is not explicitly shown by an overbar for operand B).

In some example embodiments, the SIMD accelerator performs both an ones' complement subtraction and a twos' complement subtraction as part of the byte comparison. In particular, assume that Operand B is subtracted from Operand A (A-B). Operand B can be inverted and added to Operand A to provide for the subtraction of Operand B from Operand A. For ones' complement subtraction where there is no carry in, there is a carry out of 1 if A>B (otherwise if there is no carry out, A<=B). For a two's complement subtraction that includes a carry in of 1, there is a carry out of 1 if A>=B (otherwise if there is no carry out, A<B).

As further described below, some example embodiments reuse results from logical functions that include both ones' complement and twos' complement subtraction in a SIMD accelerator to determine whether two bytes, half-words, etc. are less than, greater than or equal to each other. In some example embodiments, generate and propagate results from bit operations from the ones' complement and twos' complement subtraction is reused. A generate (g) is defined as occurring if a carry out occurs to the next set of bits. A propagate (p) is defined as occurring if a carry in is carried forward to the next set of bits.

Applications of this SIMD accelerator can include database searches wherein alphanumeric strings are compared for matches of text, documents, etc. Some example embodiments reduces the fan in into the SIMD accelerator because the less than, greater than, and equal to operations are performed across the entire two operands for each of the bytes, half-words, etc.

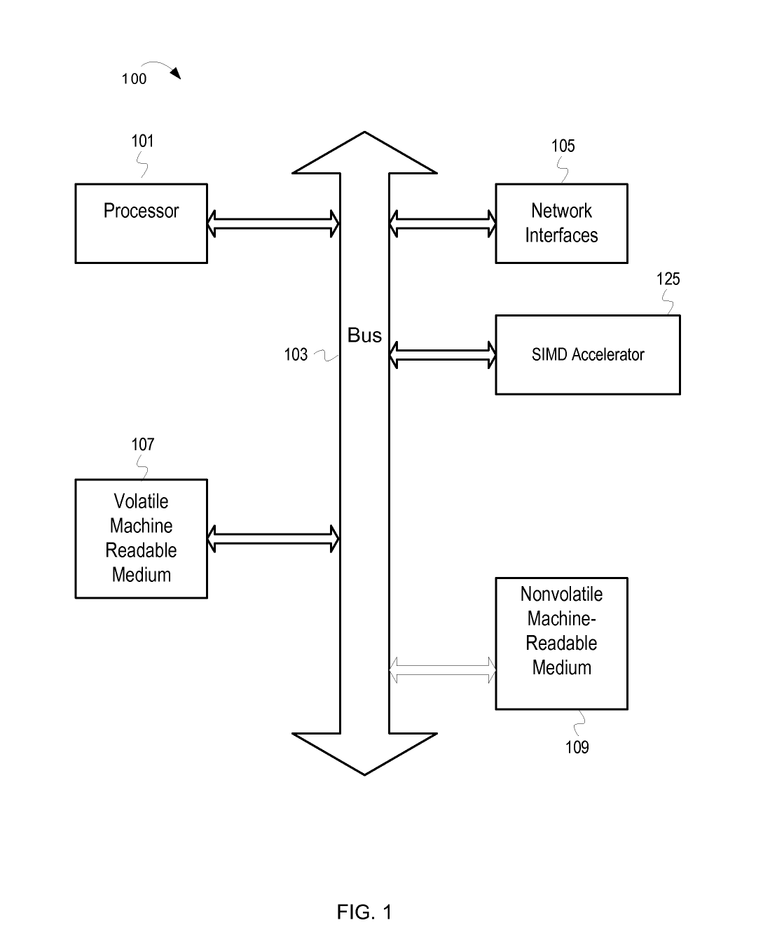

FIG. 1 depicts a computer system, according to some example embodiments. A computer system 100 includes a processor 101 (possibly including multiple processors, multiple cores, multiple nodes, and/or implementing multi-threading, etc.). The computer system 100 includes a volatile machine-readable medium 107. The volatile machine-readable medium 107 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 103 (e.g., PCI, ISA, PCI-Express, HyperTransport®, InfiniBand®, NuBus, etc.), a network interface 105 (e.g., an ATM interface, an Ethernet interface, a Frame Relay interface, SONET interface, wireless interface, etc.), and a nonvolatile machine-readable medium 109 (e.g., optical storage, magnetic storage, etc.).

The computer system 100 includes a SIMD accelerator 125 that can perform the operations for comparison of two sets of data (as further described below). While illustrated as being coupled to the processor 101 through the bus 103, in some other example embodiments, the SIMD accelerator 125 can be coupled to the processor 101 through a dedicated bus or connection. In some example embodiments, the processor 101 can receive instructions to compare two sets of data. For example, the processor 101 can receive instructions to compare two documents to determine if the documents are equal based on comparison of alphanumeric strings within the documents. The processor 101 can then send an instruction to the SIMD accelerator 125 to compare the two sets of data to determine if they are equal. As further described below, the two sets of data can be input as two operands that each comprises multiple sections of data (e.g., multiple bytes, half-words, words, etc.). In some example embodiments, the SIMD accelerator 125 performs a single instruction on these multiple sections of data between the two operands. For example, assume the two operands each comprise two bytes. The SIMD accelerator 125 compares byte 1 of operand A to byte 1 of operand B; compares byte 2 of operand A to byte 1 of operand B; compares byte 1 of operand A to byte 2 of operand B; and compares byte 2 of operand A to byte 2 of operand B.

In some example embodiments, the SIMD accelerator 125 performs three different comparisons for the same two operands: 1) greater than, 2) less than, and 3) equal to. In some example embodiments, the SIMD accelerator 125 reuses the generate and propagate results for both 1's complement and 2's complement operations for the two operands to determine if the two operands are greater than, less than, or equal to each other.

Further, realizations may include fewer or additional components not illustrated in FIG. 1 (e.g., video cards, audio cards, additional network interfaces, peripheral devices, etc.). The processor 101, the nonvolatile machine-readable medium 109, and the network interface 105 are coupled to the bus 103. Although illustrated as being coupled to the bus 103, the memory 107 may be coupled to the processor 101.

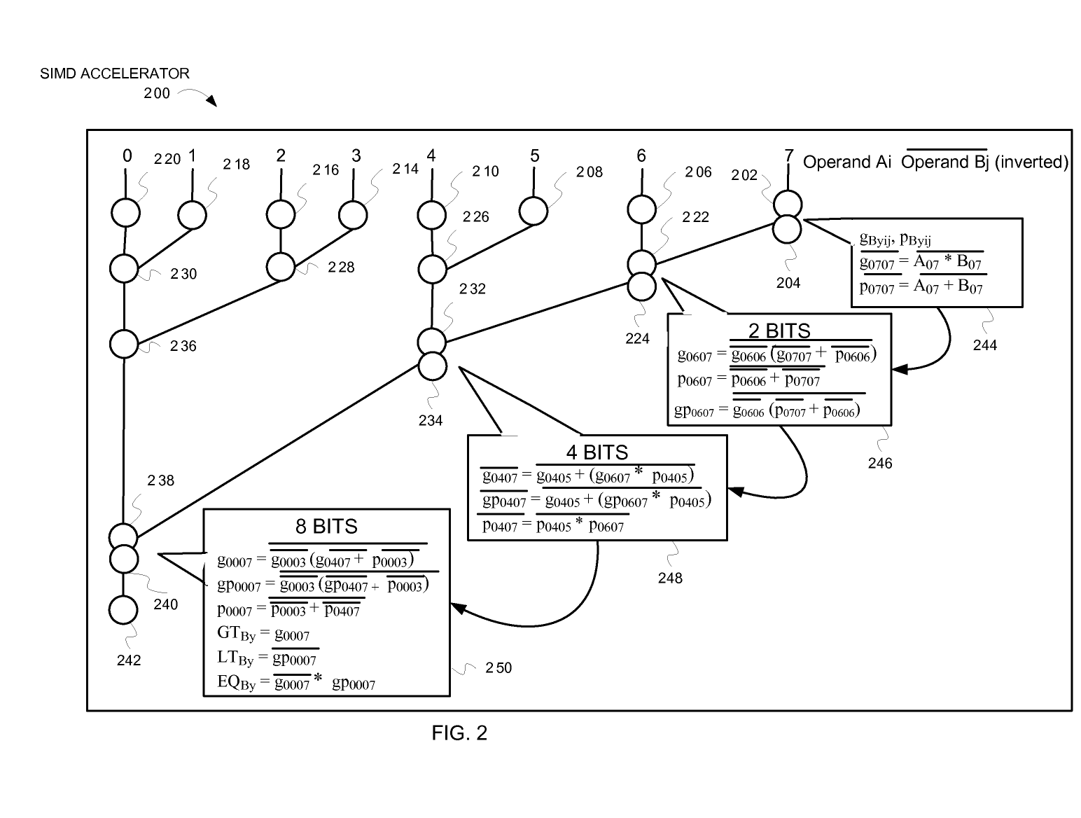

FIGS. 2-4 depicts more detailed diagrams of logical functions of a SIMD accelerator and are described relative to a number of logical equations as illustrated in the Figures and description below. A “*” represents an AND operation. A “+” represents an OR operation. Also, a variable adjacent to a parenthesis is consider an AND operation. To illustrate, the following two equations would be equal:

gp0007= \overline{\overline{g0003}*(\overline{gp0407}+\overline{p00003}}) gp0007= \overline{\overline{g0003}(\overline{gp0407}+\overline{p00003}})

FIG. 2 depicts a more detailed diagram of logical functions of a SIMD accelerator having reuse of such functions for byte comparison of two operands, according to some example embodiments. The different bubbles in FIG. 2 represent different logical functions that are executed to determine if two operands are equal (as further described below). In this example, a SIMD accelerator 200 is comparing Operand A to Operand B to determine if Operand A is equal to Operand B. An example application can be a comparison of two alphanumeric strings. Operand A is equal to Operand B based on Equation 0:

EQ=(not A>B)*(A>=B) (Equation 0)

In other words, A is equal to B if the following two conditions are true: 1) A is not greater than B and 2) A is greater than or equal to B.

In this example, the SIMD accelerator 200 is comparing a byte (8 bits) of Operand A to a byte (8 bits) of Operand B. The SIMD accelerator 200 inputs the Operand A and Operand B. The SIMD accelerator 200 includes a number of logical functions (a logical function 202, a logical function 204, a logical function 206, a logical function 208, a logical function 210, a logical function 214, a logical function 216, a logical function 218, a logical function 220, a logical function 222, a logical function 224, a logical function 226, a logical function 228, a logical function 230, a logical function 232, a logical function 234, a logical function 236, a logical function 238, a logical function 240, and a logical function 242). As further described below, the logical functions 202-242 comprise different logical gates that create propagate bits and generate (carry) bits during the logical operation. Also, some example embodiments comprise both ones' complement and twos' complement logic during these logic operations. In this example, the following logic functions perform a ones' complement operation: the logical function 202, the logical function 206, the logical function 208, the logical function 210, the logical function 214, the logical function 216, the logical function 218, the logical function 220, the logical function 222, the logical function 226, the logical function 228, the logical function 230, the logical function 232, the logical function 236, and the logical function 238. In this example, the following logic functions are add-ons to perform a twos' complement operation: the logical function 204, the logical function 224, the logical function 234 and the logical function 240. Additionally, the logical function 242 performs the equal function.

In some example embodiments, the logical functions at the same depths in FIG. 2 are performed at least partially in parallel. For example, the logical functions 202, 206, 208, 210, 214, 216, 218, and 220 are performed at least partially in parallel. For another example, the logical functions 222, 226, 228, and 230 are performed at least partially in parallel. In this example of FIG. 2, a number of results include an overhead line (representing an inverse result).

As shown in Equation 1 below, the logical function 202 performs a logical AND (inverted) of Operand A (byte 0, bit 7) and Operand B (byte 0, bit 7) to determine whether there is a carry out (generate-g₀₇₀₇) from bit 7 (inverted):

g̅₀̅₇̅₀̅₇̅= A̅₀̅₇̅*̅B̅₀̅₇̅ (Equation 1)

As described above, for the formulas provided herein, it is assumed that the operand B is inverted (for ease of use this is not explicitly shown by an overbar for operand B). As shown in Equation 2 below, the logical function 204 performs a logical OR (inverted) of Operand A (byte 0, bit 7) and Operand B (byte 0, bit 7) to determine whether there is a propagate from bit 7 (inverted):

p̅₀̅₇̅₀̅₇̅= A̅₀̅₇̅+̅B̅₀̅₇̅ (Equation 2)

As shown in Equations 3 below, the logical function 206 performs a logical AND (inverted) of Operand A (byte 0, bit 6) and Operand B (byte 0, bit 6) to determine a generate (g₀₆₀₆) and propagate (p₀₆₀₆) for bit 6 (inverted):

g̅₀̅₆̅₀̅₆̅= A̅₀̅₆̅*̅B̅₀̅₆̅ and p̅₀̅₆̅₀̅₆̅= A̅₀̅₆̅+̅B̅₀̅₆̅ (Equations 3)

As shown in Equations 4 below, the logical function 208 performs a logical AND (inverted) of Operand A (byte 0, bit 5) and Operand B (byte 0, bit 5) to determine a generate (g₀₅₀₅) and propagate (p₀₅₀₅) for bit 5 (inverted):

g̅₀̅₅̅₀̅₅̅= A̅₀̅₅̅*̅B̅₀̅₅̅ and p̅₀̅₅̅₀̅₅̅= A̅₀̅₅̅+̅B̅₀̅₅̅ (Equations 4)

As shown in Equations 5 below, the logical function 210 performs a logical AND (inverted) of Operand A (byte 0, bit 4) and Operand B (byte 0, bit 4) to determine a generate (g₀₄₀₄) and propagate (p₀₄₀₄) for bit 4 (inverted):

g̅₀̅₄̅₀̅₄̅= A̅₀̅₄̅*̅B̅₀̅₄̅ and p̅₀̅₄̅₀̅₄̅= A̅₀̅₄̅+̅B̅₀̅₄̅ (Equations 5)

As shown in Equations 6 below, the logical function 214 performs a logical AND (inverted) of Operand A (byte 0, bit 3) and Operand B (byte 0, bit 3) to determine a generate (g₀₃₀₃) and propagate (p₀₃₀₃) for bit 3 (inverted):

g̅₀̅₃̅₀̅₃̅= A̅₀̅₃̅*̅B̅₀̅₃̅ and p̅₀̅₃̅₀̅₃̅= A̅₀̅₃̅+̅B̅₀̅₃̅ (Equations 6)

As shown in Equations 7 below, the logical function 216 performs a logical AND (inverted) of Operand A (byte 0, bit 2) and Operand B (byte 0, bit 2) to determine a generate (g₀₂₀₂) and propagate (p₀₂₀₂) for bit 2 (inverted):

g̅₀̅₂̅₀̅₂̅= A̅₀̅₂̅*̅B̅₀̅₂̅ and p̅₀̅₂̅₀̅₂̅= A̅₀̅₂̅+̅B̅₀̅₂̅ (Equations 7)

As shown in Equations 8 below, the logical function 218 performs a logical AND (inverted) of Operand A (byte 0, bit 1) and Operand B (byte 0, bit 1) to determine a generate (g₀₁₀₁) and propagate (p₀₁₀₁) for bit 1 (inverted):

g̅₀̅₁̅₀̅₁̅= A̅₀̅₁̅*̅B̅₀̅₁̅ and p̅₀̅₁̅₀̅₁̅= A̅₀̅₁̅+̅B̅₀̅₁̅ (Equations 8)

As shown in Equations 9 below, the logical function 220 performs a logical AND (inverted) of Operand A (byte 0, bit 0) and Operand B (byte 0, bit 0) to determine a generate (g₀₀₀₀) and propagate (p₀₀₀₀) for bit 0 (inverted):

g̅₀̅₀̅₀̅₀̅= A̅₀̅₀̅*̅B̅₀̅₀̅and p̅₀̅₀̅₀̅₀̅= A̅₀̅₀̅+̅B̅₀̅₀̅ (Equations 9)

In some example embodiments, the subsequent logical functions to be executed in the SIMD accelerator 200 reuse the propagate and generate that were previously determined (as is now described). Accordingly, the SIMD accelerator 200 can leverage the determinations for the propagate and generate of the prior bits. These logical functions are provided to the multi-bit logical functions for reuse therein (as described below). As shown in FIG. 2, results 244 from the logical functions 202 and 204 are reused in the 2-bit logical functions (as is now described).

As shown in Equation 10, the logical function 222 performs logical OR and AND operations to determine whether there is a carry out (generate) from bit position 6:

g0607= \overline{\overline{g0606}(\overline{g0707}+\overline{p0606}}) (Equation 10)

In particular, the logical function 222 determines whether there is a carry out from bit 6 (g₀₆₀₆) (inverted) and either a carry out (generate) from bit 7 (g₀₇₀₇) (inverted) OR a propagate from bit 6 (p₀₆₀₆) (inverted). This determination is then inverted. Such logic converts into a carry out from bit 6 (g₀₆₀₆) OR a carry out (generate) from bit 7 (g₀₇₀₇) AND a propagate from bit 6 (p₀₆₀₆). If these conditions are true, then there is a carry out (generate) from bits 6 and 7. As shown, the generate from bit 7 (g₀₇₀₇) from the logical function 202 is reused to determine the generate from bits 6 and 7. Also, the logical function 222 uses the generate result from the logical function 206 (g₀₆₀₆) for making its determination.

As shown in Equation 11 below, the logical function 224 performs a logical OR operation to determine whether there is a propagate from bit positions 6-7 based on a twos' complement operation where there is carry in of 1:

p0607= \overline{\overline{p0606}+\overline{p0707}} (Equation 11)

In particular, the logical function 224 determines whether there is a propagate from bit 6 (p₀₆₀₆) (inverted) OR a propagate from bit 7 (p₀₇₀₇) (inverted). This determination is then inverted. Such logic converts into having a propagate from bits 6-7 if there is a propagate from bit 6 (p₀₆₀₆) AND a propagate from bit 7 (p₀₇₀₇). As shown, the logical function 224 reuses results from other logical functions to make this determination: 1) the logical function 222 to determine the propagate from bit 6 (p₀₆₀₆) and 2) the logical function 204 to determine the propagate from bit 7 (p₀₇₀₇).

As shown in Equation 12, the logical function 226 performs logical OR and AND operations to determine whether there is a carry out (generate) from bit positions 4 and 5 based on a ones' complement operation where there is no carry in:

g0405= \overline{\overline{g0404}(\overline{g0505}+\overline{p0404}}) (Equation 12)

In particular, the logical function 226 determines whether there is a carry out from bit 4 (g₀₄₀₄) (inverted) and either a carry out (generate) from bit 5 (g₀₅₀₅) (inverted) OR a propagate from bit 4 (p₀₄₀₄) (inverted). If these conditions are true, then there is a carry out (generate) from bits 4 and 5. As shown, the logical function 226 reuses results from other logical functions to make this determination: 1) the logical function 210 to determine the carry out (generate) from bit 4 (g₀₄₀₄) and 2) the logical function 208 to determine the carry out (generate) from bit 5 (g₀₅₀₅).

As shown in Equation 13, the logical function 228 performs logical OR and AND operations to determine whether there is a carry out (generate) from bit positions 2 and 4 based on a ones' complement operation where there is no carry in:

g₀₂₀₃= \overline{\overline{g0202}(\overline{g₀₃₀₃}+\overline{p₀₂₀₂}}) (Equation 13)

In particular, the logical function 228 determines an inverted result of a carry out from bit 2 (g₀₂₀₂) (inverted) and either a carry out (generate) from bit 3 (g₀₃₀₃) (inverted) OR a propagate from bit 2 (p₀₂₀₂) (inverted). If these conditions are true, then there is a carry out (generate) from bits 2 and 3. As shown, the logical function 228 reuses results from other logical functions to make this determination: 1) the logical function 216 to determine the carry out (generate) from bit 2 (g₀₂₀₂) and 2) the logical function 214 to determine the carry out (generate) from bit 3 (g₀₃₀₃).

As shown in Equation 14, the logical function 230 performs logical OR and AND operations to determine whether there is a carry out (generate) from bit positions 0 and 1 based on a ones' complement operation where there is no carry in:

g0001= \overline{\overline{g0000}(\overline{g0101}+\overline{p0000}}) (Equation 14)

In particular, the logical function 230 determines an inverted result of a carry out from bit 0 (g₀₀₀₀) (inverted) and either a carry out (generate) from bit 1 (g₀₁₀₁) (inverted) OR a propagate from bit 0 (p₀₀₀₀) (inverted). If these conditions are true, then there is a carry out (generate) from bits 0 and 1. As shown, the logical function 230 reuses results from other logical functions to make this determination: 1) the logical function 220 to determine the carry out (generate) from bit 0 (g₀₀₀₀) and 2) the logical function 218 to determine the carry out (generate) from bit 1 (g₀₁₀₁).

As shown in FIG. 2, results 246 from the logical functions 222 and 224 are reused in the 4-bit logical functions (as is now described). As shown in Equation 15, the logical function 232 performs logical OR and AND operations to determine whether there is a carry out (generate) from bit positions 4-7:

g̅₀̅₄̅₀̅₇̅= g̅₀̅₄̅₀̅₄̅+̅(̅g̅₀̅₆̅₀̅₇̅*̅p̅₀̅₄̅₀̅₅̅)̅ (Equation 15)

In particular, the logical function 232 determines an inverted result of a carry out from bits 4 and 5 (g₀₄₀₅) OR a carry out (generate) from bits 6 and 7 (g₀₆₀₇) AND a propagate from bits 4 and 5 (p₀₄₀₅). As shown, the logical function 232 reuses results from other logical functions to make this determination: 1) the logical function 226 to determine the carry out (generate) from bits 4 and 5 (g₀₄₀₅) and 2) the logical function 222 to determine the carry out (generate) from bits 6 and 7 (g₀₆₀₇).

As shown in Equation 16, the logical function 232 also performs logical OR and AND operations to determine whether there is a carry out (generate) from bit positions 4-7 AND a propagate from bit positions 4-7:

g̅p̅₀̅₄̅₀̅₇̅= g̅₀̅₄̅₀̅₄̅+̅(̅g̅p̅₀̅₆̅₀̅₇̅*̅p̅₀̅₄̅₀̅₅̅)̅ (Equation 16)

In particular, the logical function 232 determines an inverted result of a carry out from bits 4 and 5 (g₀₄₀₅) OR a generate/propagate from bits 6 and 7 (gp₀₆₀₇) AND a propagate from bits 4 and 5 (p₀₄₀₅). As shown, the logical function 232 reuses results from other logical functions to make this determination: 1) the logical function 226 to determine the carry out (generate) from bits 4 and 5 (g₀₄₀₅) and 2) the logical function 224 to determine the propagate from bits 6 and 7 (p₀₆₀₇). Also, the logical function 232 can reuse its previous determination regarding the propagate from bits 4 and 5 (p₀₄₀₅) from Equation 15.

As shown in Equation 17 below, the logical function 234 performs logical OR and AND operations to determine whether there is a propagate from bit positions 4-7 based on a twos' complement operation where there is carry in of 1:

p̅₀̅₄̅₀̅₇̅= p̅₀̅₄̅₀̅₅̅*̅p̅₀̅₆̅₀̅₇̅ (Equation 17)

In particular, the logical function 234 determines an inverted result of a propagate from bits 4-5 (p₀₄₀₅) AND a propagate from bits 6-7 (p₀₆₀₇). As shown, the logical function 234 reuses results from other logical functions to make this determination: 1) the logical function 232 to determine the propagate from bits 4-5 (p₀₄₀₅) and 2) the logical function 224 to determine the propagate from bits 6-7 (p₀₆₀₇).

As shown in Equations 18, the logical function 236 performs logical OR and AND operations to determine whether there is a carry out (generate) and propagate from bit positions 0-3:

g̅₀̅₀̅₀̅₃̅= g̅₀̅₀̅₀̅₁̅+̅(̅g̅₀̅₂̅₀̅₃̅*̅p̅₀̅₀̅₀̅₁̅)̅ and p̅₀̅₀̅₀̅₃̅= p̅₀̅₀̅₀̅₁̅*̅p̅₀̅₂̅₀̅₃̅ (Equations 18)

In particular, the logical function 236 determines an inverted result of a carry out from bits 0 and 1 (g₀₀₀₁) OR a carry out (generate) from bits 2 and 3 (g₀₂₀₃) AND a propagate from bits 0 and 1 (p₀₀₀₁). As shown, the logical function 236 reuses results from other logical functions to make this determination: 1) the logical function 228 to determine the carry out (generate) from bits 2 and 3 (g₀₂₀₃) and 2) the logical function 230 to determine the carry out (generate) from bits 0 and 1 (g₀₀₀₁).

As shown in FIG. 2, results 248 from the logical functions 232 and 234 are reused in the 8-bit logical functions (results 250) (as is now described). As shown in Equations 19, the logical function 238 performs logical OR and AND operations to determine whether there is a carry out (generate) and propagate from bit positions 0-7:

g₀₀₀₇= \overline{\overline{g₀₀₀₃}(\overline{g₀₄₀₇}+\overline{p₀₀₀₃}}) (Equations 19)

In particular, the logical function 238 determines an inverted result of a carry out from bits 0-3 (g₀₀₀₃) (inverted) AND a carry out (generate) from bits 4-7 (g₀₄₀₇) (inverted) OR a propagate from bits 0-3 (p₀₀₀₃) (inverted). If these conditions are true, then there is a carry out (generate) from bits 0-7. As shown, the logical function 238 reuses results from other logical functions to make this determination: 1) the logical function 232 to determine the carry out (generate) from bits 4-7 (g₀₄₀₇) and 2) the logical function 236 to determine the carry out (generate) from bits 0-3 (g₀₀₀₃).

As shown in Equation 20, the logical function 238 also performs a logical OR operation to determine whether there is a propagate from bit positions 0-7 based on a twos' complement operation where there is carry in of 1:

p0007= \overline{\overline{p₀₀₀₃}+\overline{p₀₄₀₇}} (Equation 20)

In particular, the logical function 238 determines an inverted result of a propagate from bits 0-3 (p₀₀₀₃) (inverted) OR a propagate from bits 4-7 (p₀₄₀₇) (inverted). If either of these conditions are true, then there is a propagate from bits 0-7. As shown, the logical function 240 reuses results from other logical functions to make this determination: 1) the logical function 238 to determine the propagate from bits 0-3 (p₀₀₀₃) and 2) the logical function 234 to determine the propagate from bits 4-7 (p₀₄₀₇).

As shown in Equation 21 below, the logical function 240 performs logical OR and AND operations to determine whether there is a carry out (generate) from bit positions 0-7 AND a propagate from bit positions 0-7:

gp0007= \overline{\overline{g0003}(\overline{gp0407}+\overline{p00003}}) (Equation 21)

In particular, the logical function 240 determines an inverted result of a carry out from bits 0-3 (g₀₀₀₃) (inverted) OR a carry out (generate) OR a propagate from bits 4-7 (gp₀₄₀₇) (inverted) AND a propagate from bits 0-3 (p₀₀₀₃) (inverted). If these conditions are true, then there is a carry out (generate) AND propagate from bits 0-7. As shown, the logical function 238 reuses results from other logical functions to make this determination: 1) the logical function 232 to determine the carry out (generate) AND propagate from bits 4-7 (gp₀₄₀₇) and 2) the logical function 236 to determine the carry out (generate) from bits 0-3 (g₀₀₀₃). Also, the logical function 232 can reuse its previous determination regarding the propagate from bits 0-3 (p₀₀₀₃) from Equation 19.

As shown in Equation 22 below, the logical function 242 determines that the byte of Operand A is greater than the byte of Operand B if there is a carry out (generate) from bits 0-7:

GT_{By}=g₀₀₀₇ (Equation 22)

As shown in Equation 23 below, the logical function 242 also determines that the byte of Operand A is less than the byte of Operand B if there is a carry out (generate) AND propagate from bits 0-7 (inverted):

LT_{By}= g̅p̅0̅0̅0̅7̅ (Equation 23)

As shown in Equation 24 below, the logical function 242 also determines that the byte of Operand A is equal to the byte of Operand B if there is a carry out (generate) from bits 0-7 (g₀₀₀₇) (inverted) OR carry out (generate) AND propagate from bits 0-7:

EQ_{By}= g̅0̅0̅0̅7̅*gp0007 (Equation 24)

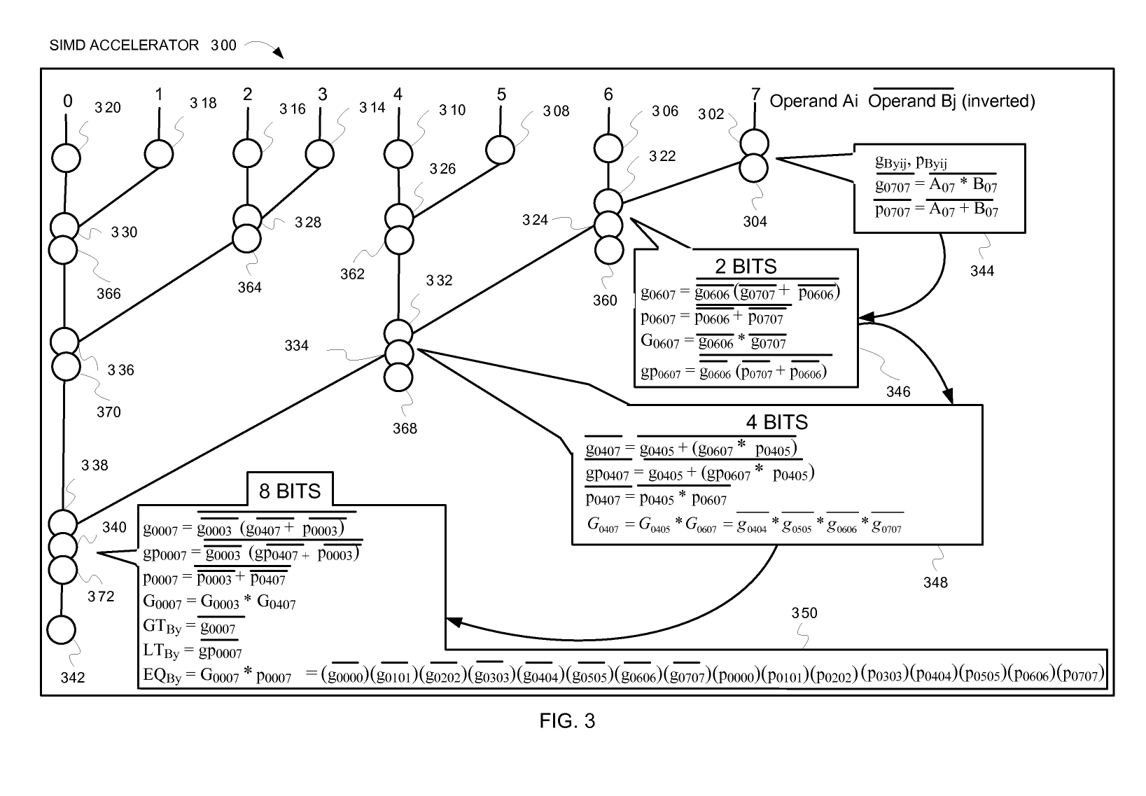

A byte compare for two operands according to some other example embodiments is now described. In particular, FIG. 3 depicts a more detailed block diagram of a SIMD accelerator having reuse of logical functions for byte comparison of two operands, according to some other example embodiments. In contrast to the SIMD accelerator 200 of FIG. 2, a SIMD accelerator 300 (FIG. 3) uses additional logical functions and a different equation (see Equation 25 below) in determining whether Operand A is equal to Operand B. The different bubbles in FIG. 3 represent different logical functions that are executed to determine if two operands are equal (as further described below). In this example, a SIMD accelerator 300 is comparing Operand A to Operand B to determine if Operand A is equal to Operand B. An example application can be a comparison of two alphanumeric strings. Operand A is equal to Operand B based on Equation 25:

EQ=( g̅ₒ̅pₒ)*( g̅₁̅p₁)*( g̅₂̅p₂) (Equation 25)

In this example, the SIMD accelerator 300 is comparing a byte (8 bits) of Operand A to a byte (8 bits) of Operand B. The SIMD accelerator 300 inputs the Operand A and Operand B. The SIMD accelerator 300 includes a number of logical functions (a logical function 302, a logical function 304, a logical function 306, a logical function 308, a logical function 310, a logical function 314, a logical function 316, a logical function 318, a logical function 320, a logical function 322, a logical function 324, a logical function 326, a logical function 328, a logical function 330, a logical function 332, a logical function 334, a logical function 336, a logical function 338, a logical function 340, a logical function 342, a logical function 360, a logical function 362, a logical function 364, a logical function 366, a logical function 368, a logical function 370, and a logical function 372). As further described below, the logical functions 302-342 and 360-372 comprise different logical gates that create propagate bits and generate (carry) bits during the logical operation. Also, some example embodiments comprise both ones' complement and twos' complement logic during these logic operations. In this example, the following logic functions perform a ones' complement operation: the logical function 302, the logical function 306, the logical function 308, the logical function 310, the logical function 314, the logical function 316, the logical function 318, the logical function 320, the logical function 322, the logical function 326, the logical function 328, the logical function 330, the logical function 332, the logical function 336, the logical function 338, and the logical function 342. In this example, the following logic functions perform a twos' complement operation: the logical function 304, the logical function 324, the logical function 334 and the logical function 340. The SIMD accelerator 300 includes the additional logical functions 360-372 (that are not included in the SIMD accelerator 200).

In some example embodiments, the logical functions at the same depths in FIG. 3 are performed at least partially in parallel. For example, the logical functions 302, 306, 308, 310, 314, 316, 318, and 320 are performed at least partially in parallel. For another example, the logical functions 322, 326, 328, and 330 are performed at least partially in parallel. In this example of FIG. 3, a number of results include an overhead line (representing an inverse result).

As shown in Equation 26 below, the logical function 302 performs a logical AND (inverted) of Operand A (byte 0, bit 7) and Operand B (byte 0, bit 7) to determine whether there is a carry out (generate-g₀₇₀₇) from bit 7 (inverted):

g̅₀̅₇̅₀̅₇̅= A̅₀̅₇̅*̅B̅₀̅₇̅ (Equation 26)

As shown in Equation 27 below, the logical function 304 performs a logical OR (inverted) of Operand A (byte 0, bit 7) and Operand B (byte 0, bit 7) to determine whether there is a propagate from bit 7 (inverted):

p̅₀̅₇̅₀̅₇̅= A̅₀̅₇̅+̅B̅₀̅₇̅ (Equation 27)

As shown in Equations 28 below, the logical function 306 performs a logical AND (inverted) of Operand A (byte 0, bit 6) and Operand B (byte 0, bit 6) to determine a generate (g₀₆₀₆) and a propagate (p₀₆₀₆) for bit 6 (inverted):

g̅₀̅₆̅₀̅₆̅= A̅₀̅₆̅*̅B̅₀̅₆̅ and p̅₀̅₆̅₀̅₆̅= p̅₀̅₆̅₀̅₆̅= A̅₀̅₆̅+̅B̅₀̅₆̅ (Equations 28)

As shown in Equations 29 below, the logical function 308 performs a logical AND (inverted) of Operand A (byte 0, bit 5) and Operand B (byte 0, bit 5) to determine a generate (g₀₅₀₅) and a propagate (p₀₅₀₅) for bit 5 (inverted):

g̅₀̅₅̅₀̅₅̅= A̅₀̅₅̅*̅B̅₀̅₅̅ and p̅₀̅₅̅₀̅₅̅= A̅₀̅₅̅+̅B̅₀̅₅̅ (Equations 29)

As shown in Equations 30 below, the logical function 310 performs a logical AND (inverted) of Operand A (byte 0, bit 4) and Operand B (byte 0, bit 4) to determine a generate (g₀₄₀₄) and a propagate (p₀₄₀₄) for bit 4 (inverted):

g̅₀̅₄̅₀̅₄̅= A̅₀̅₄̅*̅B̅₀̅₄̅ and p̅₀̅₄̅₀̅₄̅ and p̅₀̅₄̅₀̅₄̅= A̅₀̅₄̅+̅B̅₀̅₄̅ (Equations 30)

As shown in Equations 31 below, the logical function 314 performs a logical AND (inverted) of Operand A (byte 0, bit 3) and Operand B (byte 0, bit 3) to determine a generate (g₀₃₀₃) and a propagate (p₀₃₀₃) for bit 3 (inverted):

g̅₀̅₃̅₀̅₃̅= A̅₀̅₃̅*̅B̅₀̅₃̅ and p̅₀̅₃̅₀̅₃̅− A̅₀̅₃̅+̅B̅₀̅₃̅ (Equations 31)

As shown in Equations 32 below, the logical function 316 performs a logical AND (inverted) of Operand A (byte 0, bit 2) and Operand B (byte 0, bit 2) to determine a generate (g₀₂₀₂) and a propagate (p₀₂₀₂) for bit 2 (inverted):

g̅₀̅₂̅₀̅₂̅= A̅₀̅₂̅*̅B̅₀̅₂̅ and p̅₀̅₂̅₀̅₂̅= A̅₀̅₂̅+̅B̅₀̅₂̅ (Equations 32)

As shown in Equations 33 below, the logical function 318 performs a logical AND (inverted) of Operand A (byte 0, bit 1) and Operand B (byte 0, bit 1) to determine a generate (g₀₁₀₁) and a propagate (p₀₁₀₁) for bit 1 (inverted):

g̅₀̅₁̅₀̅₁̅= A̅₀̅₁̅*̅B̅₀̅₁̅ and p̅₀̅₁̅₀̅₁̅= A̅₀̅₁̅+̅B̅₀̅₁̅ (Equations 33)

As shown in Equations 34 below, the logical function 320 performs a logical AND (inverted) of Operand A (byte 0, bit 0) and Operand B (byte 0, bit 0) to determine a generate (g₀₀₀₀) and a propagate (p₀₀₀₀) for bit 0 (inverted):

g̅₀̅₀̅₀̅₀̅= A̅₀̅₀̅*̅B̅₀̅₀̅ and p̅₀̅₀̅₀̅₀̅= A̅₀̅₀̅+̅B̅₀̅₀̅ (Equations 34)

In some example embodiments, the subsequent logical functions to be executed in the SIMD accelerator 300 reuse the propagate and generate that were previously determined (as is now described). Accordingly, the SIMD accelerator 200 can leverage the determinations for the propagate and generate of the prior bits. These logical functions are provided to the multi-bit logical functions for reuse therein (as described below). As shown in FIG. 3, results 344 from the logical functions 302 and 304 are reused in the 2-bit logical functions (as is now described).

As shown in Equations 35, the logical function 322 performs logical OR and AND operations to determine whether there is a carry out (generate) from bit position 6:

g0607= \overline{\overline{g0606}(\overline{g0707}+\overline{p0606}}) and p̅₀̅₆̅₀̅₇̅= p̅₀̅₆̅₀̅₆̅*̅p̅₀̅₇̅₀̅₇̅ (Equations 35)

In particular, the logical function 322 determines whether there is a carry out from bit 6 (g₀₆₀₆) (inverted) and either a carry out (generate) from bit 7 (g₀₇₀₇) (inverted) OR a propagate from bit 6 (p₀₆₀₆) (inverted). This determination is then inverted. If these conditions are true, then there is a carry out (generate) from bits 6 and 7. As shown, the generate from bit 7 (g₀₇₀₇) from the logical function 302 is reused to determine the generate from bits 6 and 7. Also, the logical function 322 uses the generate result from the logical function 306 (g₀₆₀₆) for making its determination.

Also, the logical function 322 performs a logical OR operation to determine whether there is a propagate from bit positions 6-7 based on a twos' complement operation where there is carry in of 1. In particular, the logical function 322 determines whether there is a propagate from bit 6 (p₀₆₀₆) (inverted) OR a propagate from bit 7 (p₀₇₀₇) (inverted). This determination is then inverted. If the determination is true, then there is a propagate from bits 6 and 7. As shown, the logical function 322 reuses results from other logical functions to make this determination: 1) the logical function 322 to determine the propagate from bit 6 (p₀₆₀₆) and 2) the logical function 304 to determine the propagate from bit 7 (p₀₇₀₇).

As shown in Equation 36 below, the logical function 324 performs logical OR and AND operations to determine whether there is a generate/propagate from bit positions 6-7:

gp₀₆₀₇= \overline{\overline{g₀₆₀₆}(\overline{p₀₇₀₇}+\overline{p₀₆₀₆}}) (Equation 36)

In particular, the logical function 324 determines whether there is a generate from bit 6 (g₀₆₀₆) (inverted) and either a propagate from bit 7 (p₀₇₀₇) (inverted) OR a propagate from bit 6 (inverted). This determination is then inverted. If the determination is true, then there is a generate/propagate from bits 6 and 7. As shown, the logical function 324 reuses results from other logical functions to make this determination: 1) the logical function 322 to determine the propagate from bit 6 (p₀₆₀₆) and 2) the logical function 304 to determine the propagate from bit 7 (p₀₇₀₇).

As shown in Equation 37 below, the logical function 360 performs a logical AND operation to determine whether there is a generate from both bit positions 6 and 7:

G0607= g̅₀̅₆̅₀̅₆̅* g̅₀̅₇̅₀̅₇̅ (Equation 37)

In particular, the logical function 360 determines whether there is a generate from bit 6 (g₀₆₀₆) (inverted) AND a generate from bit 7 (g₀₇₀₇) (inverted). As shown, the logical function 360 reuses results from other logical functions to make this determination: 1) the logical function 306 to determine the generate from bit 6 (g₀₆₀₆) and 2) the logical function 302 to determine the generate from bit 7 (g₀₇₀₇). As further described below and in contrast to the SIMD accelerator 200 of FIG. 2, the SIMD accelerator 300 uses the result from this logical function 360 to determine if Operand A is equal to Operand B (see description of the logical function 372 below).

As shown in Equations 38, the logical function 326 performs logical OR and AND operations to determine whether there is a carry out (generate) from bit positions 4 and 5:

g0405= \overline{\overline{g0404}(\overline{g0505}+\overline{p0404}}) and p₀₄₀₅= \overline{\overline{p₀₅₀₅}+\overline{p₀₄₀₄}} (Equations 38)

In particular, the logical function 326 determines whether there is a carry out from bit 4 (g₀₄₀₄) (inverted) and either a carry out (generate) from bit 5 (g₀₅₀₅) (inverted) OR a propagate from bit 4 (g₀₄₀₄) (inverted). If these conditions are true, then there is a carry out (generate) from bits 4 and 5. As shown, the logical function 326 reuses results from other logical functions to make this determination: 1) the logical function 310 to determine the carry out (generate) from bit 4 (g₀₄₀₄) and 2) the logical function 308 to determine the carry out (generate) from bit 5 (g₀₅₀₅).

Also, the logical function 326 performs a logical OR operation to determine whether there is a propagate from bit positions 4-5 based on a twos' complement operation where there is carry in of 1. In particular, the logical function 326 determines whether there is a propagate from bit 5 (p₀₅₀₅) (inverted) OR a propagate from bit 4 (p₀₄₀₄) (inverted). This determination is then inverted. If the determination is true, then there is a propagate from bits 4 and 5. As shown, the logical function 326 reuses results from other logical functions to make this determination: 1) the logical function 326 to determine the propagate from bit 5 (p₀₅₀₅).

As shown in Equation 39 below, the logical function 362 performs a logical AND operation to determine whether there is a generate from both bit positions 4 and 5:

G0405= g̅₀̅₄̅₀̅₄̅* g̅₀̅₅̅₀̅₅̅ (Equation 39)

In particular, the logical function 362 determines whether there is a generate from bit 4 (g₀₄₀₄) (inverted) AND a generate from bit 5 (g₀₅₀₅) (inverted). As shown, the logical function 362 reuses results from other logical functions to make this determination: 1) the logical function 310 to determine the generate from bit 4 (g₀₄₀₄) and 2) the logical function 308 to determine the generate from bit 5 (g₀₅₀₅). As further described below and in contrast to the SIMD accelerator 200 of FIG. 2, the SIMD accelerator 300 uses the result from this logical function 362 to determine if Operand A is equal to Operand B (see description of the logical function 372 below).

As shown in Equations 40, the logical function 328 performs logical OR and AND operations to determine whether there is a carry out (generate) from bit positions 2 and 4:

g0203= \overline{\overline{g0202}(\overline{g0303}+\overline{p0202}}) and p₀₂₀₃= \overline{\overline{p₀₂₀₂}+\overline{p₀₃₀₃}} (Equations 40)

In particular, the logical function 328 determines an inverted result of a carry out from bit 2 (g₀₂₀₂) (inverted) and either a carry out (generate) from bit 3 (g₀₃₀₃) (inverted) OR a propagate from bit 2 (p₀₂₀₂) (inverted). If these conditions are true, then there is a carry out (generate) from bits 2 and 3. As shown, the logical function 328 reuses results from other logical functions to make this determination: 1) the logical function 316 to determine the carry out (generate) from bit 2 (g₀₂₀₂) and 2) the logical function 314 to determine the carry out (generate) from bit 3 (g₀₃₀₃).

Also, the logical function 328 performs a logical OR operation to determine whether there is a propagate from bit positions 2-3 based on a twos' complement operation where there is carry in of 1. In particular, the logical function 328 determines whether there is a propagate from bit 2 (p₀₂₀₂) (inverted) OR a propagate from bit 3 (p₀₃₀₃) (inverted). This determination is then inverted. If the determination is true, then there is a propagate from bits 2 and 3. As shown, the logical function 328 reuses results from other logical functions to make this determination: 1) the logical function 328 to determine the propagate from bit 2 (p₀₂₀₂).

As shown in Equation 41 below, the logical function 364 performs a logical AND operation to determine whether there is a generate from both bit positions 2 and 3:

G0203= g̅₀̅₂̅₀̅₂̅* g̅₀̅₃̅₀̅₃̅ (Equation 41)

In particular, the logical function 364 determines whether there is a generate from bit 2 (g₀₂₀₂) (inverted) AND a generate from bit 3 (g₀₃₀₃) (inverted). As shown, the logical function 364 reuses results from other logical functions to make this determination: 1) the logical function 316 to determine the generate from bit 2 (g₀₂₀₂) and 2) the logical function 314 to determine the generate from bit 3 (g₀₃₀₃). As further described below and in contrast to the SIMD accelerator 200 of FIG. 2, the SIMD accelerator 300 uses the result from this logical function 364 to determine if Operand A is equal to Operand B (see description of the logical function 372 below).

As shown in Equations 42, the logical function 330 performs logical OR and AND operations to determine whether there is a carry out (generate) from bit positions 0 and 1 based on a ones' complement operation where there is no carry in:

g0001= \overline{\overline{g0000}(\overline{g0101}+\overline{p0000}}) and p₀₀₀₁= \overline{\overline{p₀₀₀₀}+\overline{p₀₁₀₁}} (Equations 42)

In particular, the logical function 330 determines an inverted result of a carry out from bit 0 (g₀₀₀₀) (inverted) and either a carry out (generate) from bit 1 (g₀₁₀₁) (inverted) OR a propagate from bit 0 (p₀₀₀₀) (inverted). If these conditions are true, then there is a carry out (generate) from bits 0 and 1. As shown, the logical function 330 reuses results from other logical functions to make this determination: 1) the logical function 320 to determine the carry out (generate) from bit 0 (g₀₀₀₀) and 2) the logical function 318 to determine the carry out (generate) from bit 1 (g₀₁₀₁).

Also, the logical function 330 performs a logical OR operation to determine whether there is a propagate from bit positions 0-1 based on a twos' complement operation where there is carry in of 1. In particular, the logical function 330 determines whether there is a propagate from bit 0 (p₀₀₀₀) (inverted) OR a propagate from bit 1 (p₀₁₀₁) (inverted). This determination is then inverted. If the determination is true, then there is a propagate from bits 0 and 1. As shown, the logical function 330 reuses results from other logical functions to make this determination: 1) the logical function 330 to determine the propagate from bit 0 (p₀₀₀₀).

As shown in Equation 43 below, the logical function 366 performs a logical AND operation to determine whether there is a generate from both bit positions 2 and 3:

G₀₀₀₁= g̅₀̅₀̅₀̅₀̅* g̅₀̅₁̅₀̅₁̅ (Equation 43)

In particular, the logical function 366 determines whether there is no generate from bit 0 (g₀₀₀₀) (inverted) AND a generate from bit 1 (g₀₁₀₁) (inverted). As shown, the logical function 366 reuses results from other logical functions to make this determination: 1) the logical function 320 to determine the generate from bit 0 (g₀₀₀₀) and 2) the logical function 318 to determine the generate from bit 1 (g₀₁₀₁). As further described below and in contrast to the SIMD accelerator 200 of FIG. 2, the SIMD accelerator 300 uses the result from this logical function 366 to determine if Operand A is equal to Operand B (see description of the logical function 372 below).

As shown in FIG. 3, results 346 from the logical functions 322, 324, and 360 are reused in the 4-bit logical functions (as is now described). As shown in Equation 44, the logical function 332 performs logical OR and AND operations to determine whether there is a carry out (generate) from bit positions 4-7:

g̅₀̅₄̅₀̅₇̅= g̅₀̅₄̅₀̅₅̅+̅(̅g̅₀̅₆̅₀̅₇̅*̅p̅₀̅₄̅₀̅₅̅)̅ (Equation 44)

In particular, the logical function 332 determines an inverted result of a carry out from bits 4 and 5 (g₀₄₀₅) OR a carry out (generate) from bits 6 and 7 (g₀₆₀₇) AND a propagate from bits 4 and 5 (p₀₄₀₅). As shown, the logical function 332 reuses results from other logical functions to make this determination: 1) the logical function 326 to determine the carry out (generate) from bits 4 and 5 (g₀₄₀₅) and 2) the logical function 322 to determine the carry out (generate) from bits 6 and 7 (g₀₆₀₇).

As shown in Equation 45 below, the logical function 332 also performs a logical AND operation to determine whether there is a propagate from bit positions 4-7 based on a twos' complement operation where there is carry in of 1:

p̅₀̅₄̅₀̅₇̅= p̅₀̅₄̅₀̅₅̅*̅p̅₀̅₆̅₀̅₇̅ (Equation 45)

In particular, the logical function 332 determines an inverted result of a propagate from bits 4-5 (p₀₄₀₅) AND a propagate from bits 6-7 (p₀₆₀₇). As shown, the logical function 334 reuses results from other logical functions to make this determination: 1) the logical function 332 to determine the propagate from bits 4-5 (p₀₄₀₅) and 2) the logical function 324 to determine the propagate from bits 6-7 (p₀₆₀₇).

As shown in Equation 46, the logical function 334 also performs logical OR and AND operations to determine whether there is a carry out (generate) from bit positions 4-7 AND a propagate from bit positions 4-7:

g̅p̅₀̅₄̅₀̅₇̅= g̅₀̅₄̅₀̅₅̅+̅(̅g̅p̅₀̅₆̅₀̅₇̅*̅p̅₀̅₄̅₀̅₅̅)̅ (Equation 46)

In particular, the logical function 334 determines an inverted result of a carry out from bits 4 and 5 (g₀₄₀₅) OR a generate/propagate from bits 6 and 7 (p₀₆₀₇) AND a propagate from bits 4 and 5 (p₀₄₀₅). As shown, the logical function 334 reuses results from other logical functions to make this determination: 1) the logical function 326 to determine the carry out (generate) from bits 4 and 5 (g₀₄₀₅) and 2) the logical function 324 to determine the propagate from bits 6 and 7 (p₀₆₀₇). Also, the logical function 332 can reuse its previous determination regarding the propagate from bits 4 and 5 (p₀₄₀₅) from Equation 44.

As shown in Equation 47 below, the logical function 368 performs logical OR and/or AND operations to determine whether there is a generate from all of bit positions 4-7:

G₀₄₀₇=G₀₄₀₅*G₀₆₀₇= g̅₀̅₄̅₀̅₄̅* g̅₀̅₅̅₀̅₅̅*g₀₆₀₆* g̅₀̅₇̅₀̅₇̅ (Equation 47)

In particular, the logical function 368 determines a result of a generate from bit 4 (g₀₄₀₄) (inverted) AND a generate from bit 5 (g₀₅₀₅) (inverted) AND a generate from bit 6 (g₀₆₀₆) (inverted) AND a generate from bit 7 (g₀₇₀₇) (inverted). As further described below and in contrast to the SIMD accelerator 200 of FIG. 2, the SIMD accelerator 300 uses the result from this logical function 368 to determine if Operand A is equal to Operand B (see description of the logical function 372 below).

As shown in Equations 48, the logical function 336 performs logical OR and AND operations to determine whether there is a carry out (generate) from bit positions 0-3:

g̅₀̅₀̅₀̅₃̅= g̅₀̅₀̅₀̅₁̅+̅(̅g̅₀̅₂̅₀̅₃̅*̅p̅₀̅₀̅₀̅₁̅)̅ and p̅₀̅₀̅₀̅₃̅= p̅₀̅₀̅₀̅₁̅*̅p̅₀̅₂̅₀̅₃̅ (Equations 48)

In particular, the logical function 336 determines an inverted result of a carry out from bits 0 and 1 (g₀₀₀₁) OR a carry out (generate) from bits 2 and 3 (g₀₂₀₃) AND a propagate from bits 0 and 1 (p₀₀₀₁). As shown, the logical function 336 reuses results from other logical functions to make this determination: 1) the logical function 328 to determine the carry out (generate) from bits 2 and 3 (g₀₂₀₃) and 2) the logical function 330 to determine the carry out (generate) from bits 0 and 1 (g₀₀₀₁). The logical function 336 also determines an inverted result of a propagate from bits 0 and 1 (p₀₀₀₁) AND a propagate from bits 2 and 3 (p₀₂₀₃).

As shown in Equation 49 below, the logical function 370 performs logical OR and/or AND operations to determine whether there is a generate from all of bit positions 0-3:

G0003=G₀₀₀₁*G₀₂₀₃= g̅₀̅₀̅₀̅₀̅* g̅₀̅₁̅₀̅₁̅* g̅₀̅₂̅₀̅₂̅* g̅₀̅₃̅₀̅₃̅ (Equation 49)

In particular, the logical function 370 determines a result of a generate from bit 0 (g₀₀₀₀) (inverted) AND a generate from bit 1 (g₀₁₀₁) (inverted) AND a generate from bit 2 (g₀₂₀₂) (inverted) AND a generate from bit 3 (g₀₃₀₃) (inverted). As further described below and in contrast to the SIMD accelerator 200 of FIG. 2, the SIMD accelerator 300 uses the result from this logical function 370 to determine if Operand A is equal to Operand B (see description of the logical function 372 below).

As shown in FIG. 3, results 348 from the logical functions 332, 334, and 368 are reused in the 8-bit logical functions (results 350) (as is now described). As shown in Equation 50, the logical function 338 performs logical OR and AND operations to determine whether there is a carry out (generate) from bit positions 0-7:

g₀₀₀₇= \overline{\overline{g₀₀₀₃}(\overline{g₀₄₀₇}+\overline{p₀₀₀₃}}) (Equation 50)

In particular, the logical function 338 determines a result of a carry out (generate) from bits 0-3 (g₀₀₀₃) (inverted) AND a carry out (generate) from bits 4-7 (g₀₄₀₇) (inverted) OR a propagate from bits 0-3 (p₀₀₀₃) (inverted). This result is then inverted. If these conditions are true, then there is a carry out (generate) from bits 0-7. As shown, the logical function 338 reuses results from other logical functions to make this determination: 1) the logical function 332 to determine the carry out (generate) from bits 4-7 (g₀₄₀₇) and 2) the logical function 336 to determine the carry out (generate) from bits 0-3 (g₀₀₀₃).

As shown in Equation 51, the logical function 338 also performs a logical OR operation to determine whether there is a propagate from bit positions 0-7 based on a twos' complement operation where there is carry in of 1:

p0007= \overline{\overline{p0003}+\overline{p0407}} (Equation 51)

In particular, the logical function 338 determines an inverted result of a propagate from bits 0-3 (p₀₀₀₃) (inverted) OR a propagate from bits 4-7 (p₀₄₀₇) (inverted). If either of these conditions are true, then there is a propagate from bits 0-7. As shown, the logical function 338 reuses results from other logical functions to make this determination: 1) the logical function 338 to determine the propagate from bits 0-3 (p₀₀₀₃) and 2) the logical function 334 to determine the propagate from bits 4-7 (p₀₄₀₇).

As shown in Equation 52, the logical function 340 also performs logical OR and AND operations to determine whether there is a carry out (generate) from bit positions 0-7 AND a propagate from bit positions 0-7:

gp₀₀₀₇= \overline{\overline{g₀₀₀₃}(\overline{gp₀₄₀₇}+\overline{p₀₀₀₃})} (Equation 52)

In particular, the logical function 340 determines an inverted result of a carry out from bits 0-3 (g₀₀₀₃) (inverted) AND a carry out (generate) OR a propagate from bits 4-7 (gp₀₄₀₇) (inverted) AND a propagate from bits 0-3 (p₀₀₀₃) (inverted). If these conditions are true, then there is a carry out (generate) AND propagate from bits 0-7. As shown, the logical function 338 reuses results from other logical functions to make this determination: 1) the logical function 332 to determine the carry out (generate) AND propagate from bits 4-7 (gp₀₄₀₇) and 2) the logical function 336 to determine the carry out (generate) from bits 0-3 (g₀₀₀₃). Also, the logical function 332 can reuse its previous determination regarding the propagate from bits 0-3 (p₀₀₀₃) from Equation 50.

As shown in Equation 53 below, the logical function 372 performs logical AND operation to determine whether there is a generate from all of bit positions 0-3:

G₀₀₀₇=G₀₀₀₃*G₀₄₀₇ (Equation 53)

In particular, the logical function 372 determines a result of a generate from bits 0-3 (G₀₀₀₃) AND a generate from bits 4-7 (G₀₄₀₇). As shown, the logical function 372 reuses results from other logical functions to make this determination: 1) the logical function 370 to determine the generate from bits 0-3 (G₀₀₀₃) and 2) the logical function 368 to determine the generate from bits 4-7 (G₀₄₀₇).

As shown in Equation 54 below, the logical function 342 determines that the byte of Operand A is greater than the byte of Operand B if there is a carry out (generate) from bits 0-7:

GT_{By}=g₀₀₀₇ (Equation 54)

As shown in Equation 55 below, the logical function 342 also determines that the byte of Operand A is less than the byte of Operand B if there is a carry out (generate) AND propagate from bits 0-7 (inverted):

LT_{By}= g̅p̅0̅0̅0̅7̅ (Equation 55)

As shown in Equation 56 below, the logical function 342 also determines that the byte of Operand A is equal to the byte of Operand B if there is a carry out (generate) from bits 0-7 (G₀₀₀₇) AND propagate from bits 0-7:

EQ_{By}=G₀₀₀₇*p₀₀₀₇ (Equation 56)

In particular, the logical function 342 determines that Operand A is equal to Operand B if there is not a carry out (generate) of bit 0 ( g̅0̅0̅0̅0̅) AND not a carry out (generate) of bit 1 ( g̅0̅1̅0̅1̅) AND not a carry out (generate) of bit 2 ( g̅0̅2̅0̅2̅) AND not a carry out (generate) of bit 3 ( g̅0̅3̅0̅3̅) AND not a carry out (generate) of bit 4 ( g̅0̅4̅0̅4̅) AND not a carry out (generate) of bit 5 (( g̅0̅5̅0̅5̅) AND not a carry out (generate) of bit 6 ( g̅0̅6̅0̅6̅) AND not a carry out (generate) of bit 7 ( g̅0̅7̅0̅7̅) AND a propagate from bit 0 (p₀₀₀₀) AND a propagate from bit 1 (p₀₁₀₁) AND a propagate from bit 2 (p₀₂₀₂) AND a propagate from bit 3 (p₀₃₀₃) AND a propagate from bit 4 (p₀₄₀₄) AND a propagate from bit 5 (p₀₅₀₅) AND a propagate from bit 6 (p₀₆₀₆) AND a propagate from bit 7 (p₀₇₀₇).

FIGS. 2-3 depicted a SIMD accelerator wherein one byte of Operand A is compared to one byte of Operand B. However, the SIMD accelerator can compare each byte of multiple bytes of Operand A with each byte of multiple bytes of Operand B. Additionally, in some example embodiments, the SIMD accelerator can compare any size of data between the operands. For example, the SIMD accelerator can compare a half-word of Operand A with a half-word of Operand B. In some example embodiments, the half-word comparisons are based on byte comparisons.

To illustrate, FIG. 4 depicts a more detailed diagram of logical functions of a SIMD accelerator having reuse of such functions for comparison of operands for multiple bytes (two byte example), according to some example embodiments. In particular, a SIMD accelerator 400 can compare each byte of one operand (Operand A) and each byte of a second operand (Operand B), wherein the number of bytes of the operands can be one or more. The comparison can comprise a byte compare or a half-word compare. As described below, the byte compares between the two operands can be used for the half-word compare.

The SIMD accelerator 400 includes four different byte comparisons and a half-word comparison based on the byte comparisons. Each of the four different byte comparisons includes a different group of logical functions (that are similar to the logical functions illustrated in FIG. 2 or 3). A first byte comparison compares byte 0 (bits 0-7) of Operand A to byte 0 (bits 0-7) of Operand B. The first byte comparison includes logical functions 401-415. The second byte comparison compares byte 0 (bits 0-7) of Operand A to byte 1 (bits 8-15) of Operand B. The second byte comparison includes logical functions 416-429. The third byte comparison compares byte 1 (bits 8-15) of Operand A to byte 0 (bits 0-7) of Operand B. The third byte comparison includes logical functions 430-443. The fourth byte comparison compares byte 1 (bits 8-15) of Operand A to byte 1 (bits 8-15) of Operand B. The fourth byte comparison includes logical functions 444-457. In some example embodiments, each group of logical functions is equal to the logical functions in FIG. 2 or 3 (as is now described).

In some example embodiments, the logical functions 401-415 are equal to the logical functions 202-242 in the SIMD accelerator 200 of FIG. 2. In some other example embodiments, the logical functions 401-415 are equal to the logical functions 302-342 in the SIMD accelerator 300 of FIG. 3.

In this example illustrated in FIG. 4, the logical function 415 uses the logical function operations for the SIMD accelerator 300 of FIG. 3 (results 460). However, the logical function 415 can also use the logical function operations illustrated in the SIMD accelerator 200 of FIG. 2. In particular as shown in Equation 57 below, the logical function 415 determines that Operand A is greater than Operand B if there is a carry out (generate) from bits 0-7:

GT_{By}=g₀₀₀₇ (Equation 57)

As shown in Equation 58 below, the logical function 415 also determines that Operand A is less than Operand B if there is a carry out (generate) AND propagate from bits 0-7 (inverted):

LT_{By}= g̅p̅0̅0̅0̅7̅ (Equation 58)

As shown in Equation 59 below, the logical function 415 also determines that Operand A is equal to Operand B if there is a carry out (generate) from bits 0-7 (G₀₀₀₇) AND propagate from bits 0-7:

EQ_{By}=G₀₀₀₇*p₀₀₀₇ (Equation 59)

In some example embodiments, the logical functions 416-429 are equal to the logical functions 202-242 in the SIMD accelerator 200 of FIG. 2. In some other example embodiments, the logical functions 416-429 are equal to the logical functions 302-342 in the SIMD accelerator 300 of FIG. 3.

In this example illustrated in FIG. 4, the logical function 429 uses the logical function operations for the SIMD accelerator 300 of FIG. 3 (results 461). However, the logical function 429 can also use the logical function operations illustrated in the SIMD accelerator 200 of FIG. 2. In particular as shown in Equation 60 below, the logical function 429 determines that Operand A is greater than Operand B if there is a carry out (generate) from bits 0-7 of Operand A and bits 8-15 of Operand B:

GT_{By}=g₀₀₁₅ (Equation 60)

As shown in Equation 61 below, the logical function 429 also determines that Operand A is less than Operand B if there is a carry out (generate) AND propagate from bits 0-7 of Operand A and bits 8-15 of Operand B (inverted):

LT_{By}= g̅p̅0̅0̅1̅5̅ (Equation 61)

As shown in Equation 62 below, the logical function 429 also determines that Operand A is equal to Operand B if there is a carry out (generate) from bits 0-7 of Operand A and bits 8-15 of Operand B (G₀₀₁₅) AND propagate from bits 0-7 of Operand A and bits 8-15 of Operand B (p₀₀₁₅):

EQ_{By}=G₀₀₁₅*p₀₀₁₅ (Equation 62)

In this example illustrated in FIG. 4, the logical function 443 uses the logical function operations for the SIMD accelerator 300 of FIG. 3 (results 463). However, the logical function 443 can also use the logical function operations illustrated in the SIMD accelerator 200 of FIG. 2. In particular as shown in Equation 63 below, the logical function 443 determines that Operand A is greater than Operand B if there is a carry out (generate) from bits 8-15 of Operand A and bits 0-7 of Operand B:

GT_{By}=g₀₈₀₇ (Equation 63)

As shown in Equation 64 below, the logical function 443 also determines that Operand A is less than Operand B if there is a carry out (generate) AND propagate from bits 8-15 of Operand A and bits 0-7 of Operand B (inverted):

LT_{By}= g̅p̅0̅8̅0̅7̅ (Equation 64)

As shown in Equation 65 below, the logical function 443 also determines that Operand A is equal to Operand B if there is a carry out (generate) from bits 8-15 of Operand A and bits 0-7 of Operand B (G₀₈₀₇) AND propagate from bits 8-15 of Operand A and bits 0-7 of Operand B (p₀₈₀₇):

EQ_{By}=G₀₈₀₇*p₀₈₀₇ (Equation 65)

In this example illustrated in FIG. 4, the logical function 457 uses the logical function operations for the SIMD accelerator 300 of FIG. 3 (results 462). However, the logical function 457 can also use the logical function operations illustrated in the SIMD accelerator 200 of FIG. 2. In particular as shown in Equation 66 below, the logical function 457 determines that Operand A is greater than Operand B if there is a carry out (generate) from bits 8-15 of Operand A and bits 8-15 of Operand B:

GT_{By}=g₀₈₁₅ (Equation 66)

As shown in Equation 67 below, the logical function 457 also determines that Operand A is less than Operand B if there is a carry out (generate) AND propagate from bits 8-15 of Operand A and bits 8-15 of Operand B (inverted):

LT_{By}= g̅p̅0̅8̅1̅5̅ (Equation 67)

As shown in Equation 68 below, the logical function 457 also determines that Operand A is equal to Operand B if there is a carry out (generate) from bits 8-15 of Operand A and bits 8-15 of Operand B (G₀₈₁₅) AND propagate from bits 8-15 of Operand A and bits 8-15 of Operand B (p₀₈₁₅):

EQ_{By}=G₀₈₁₅*p₀₈₁₅ (Equation 68)

Additionally, the SIMD accelerator 400 is configured such that results of the byte word comparison can be reused for a half-word comparison. In particular, a logical function 458 can reuse the results from the logical function 415, the logical function 429, the logical function 443, and the logical function 457 to compare a first half-word (bytes 0 and 1) of Operand A to a first half-word (bytes 0-1) of Operand B.

As shown in Equation 69, the logical function 458 performs logical OR and AND operations to determine whether there is a carry out (generate) from bit positions 0-15:

g̅₀̅₀̅₁̅₅̅= g̅₀̅₀̅₀̅₇̅+̅(̅g̅₀̅₈̅₁̅₅̅*̅p̅0̅0̅0̅7̅) (Equation 69)

In particular, the logical function 458 determines an inverted result of a carry out from bits 0-7 (g₀₀₀₇) OR a carry out (generate) from bits 8-15 (g₀₈₁₅) AND a propagate from bits 0-7 (p₀₀₀₇). As shown, the logical function 458 reuses results from other logical functions to make this determination: 1) the logical function 415 to determine the carry out (generate) from bits 0-7 (g₀₀₀₇) and 2) the logical function 457 to determine the carry out (generate) from bits 8-15 (g₀₈₁₅).

As shown in Equation 70, the logical function 458 also performs logical OR and AND operations to determine whether there is a carry out (generate) from bit positions 0-15 AND a propagate from bit positions 0-15:

g̅p̅₀̅₀̅₁̅₅̅= g̅p̅0̅0̅1̅5̅+( g̅p̅0̅8̅1̅5̅* p̅0̅0̅0̅7̅) (Equation 70)

In particular, the logical function 458 determines an inverted result of a generate AND propagate from bits 0-15 (gp₀₀₁₅) (inverted) OR a carry out (generate) AND a propagate from bits 8-15 (gp₀₈₁₅) (inverted) AND a propagate from bits 0-7 (p₀₀₀₇) (inverted). As shown, the logical function 458 reuses results from another logical function to make this determination: the logical function 463 to determine the carry out (generate) AND propagate from bits 8-15 (gp₀₈₁₅).

As shown in Equation 71 below, the logical function 458 performs a logical OR operation to determine whether there is a propagate from bit positions 0-15 based on a twos' complement operation where there is carry in of 1:

p̅₀̅₀̅₁̅₅̅= p̅₀̅₀̅₀̅₇̅*̅p̅₀̅₈̅₁̅₅̅ (Equation 71)

In particular, the logical function 458 determines an inverted result of a propagate from bits 0-7 (p₀₀₀₇) OR a propagate from bits 8-15 (p₀₈₁₅). As shown, the logical function 443 reuses results from its previous determination regarding the propagate from bits 0-7 (p₀₀₀₇).

As shown in Equation 72 below, the logical function 458 also performs a logical AND operation to determine whether there is a generate from all of bit positions 0-15:

G₀₀₁₅=G₀₀₀₇*G₀₈₁₅ (Equation 72)

In particular, the logical function 458 determines a result of a generate from bits 0-7 (G₀₀₀₇) AND a generate from bits 8-15 (G₀₈₁₅). As shown, the logical function 458 reuses results from other logical functions to make this determination: 1) the logical function 460 to determine the generate from bits 0-7 (G₀₀₀₇) and 2) the logical function 463 to determine the generate from bits 8-15 (G₀₈₁₅).

As shown in Equation 73 below, the logical function 458 determines that the half-word of Operand A is greater than the half-word of Operand B if there is a carry out (generate) from bits 0-15:

GT_{HW}=g₀₀₁₅ (Equation 73)

As shown in Equation 74 below, the logical function 458 also determines that the half-word of Operand A is less than the half-word of Operand B if there is a carry out (generate) AND propagate from bits 0-7 (inverted):

LT_{HW}= g̅p̅0̅0̅1̅5̅ (Equation 74)

As shown in Equation 75 below, the logical function 458 also determines that the half-word of Operand A is equal to the half-word of Operand B if there is a carry out (generate) from bits 0-15 (G₀₀₁₅) AND propagate (p₀₀₁₅) from bits 0-15:

EQ_{HW}=G₀₀₁₅*p₀₀₁₅ (Equation 75)

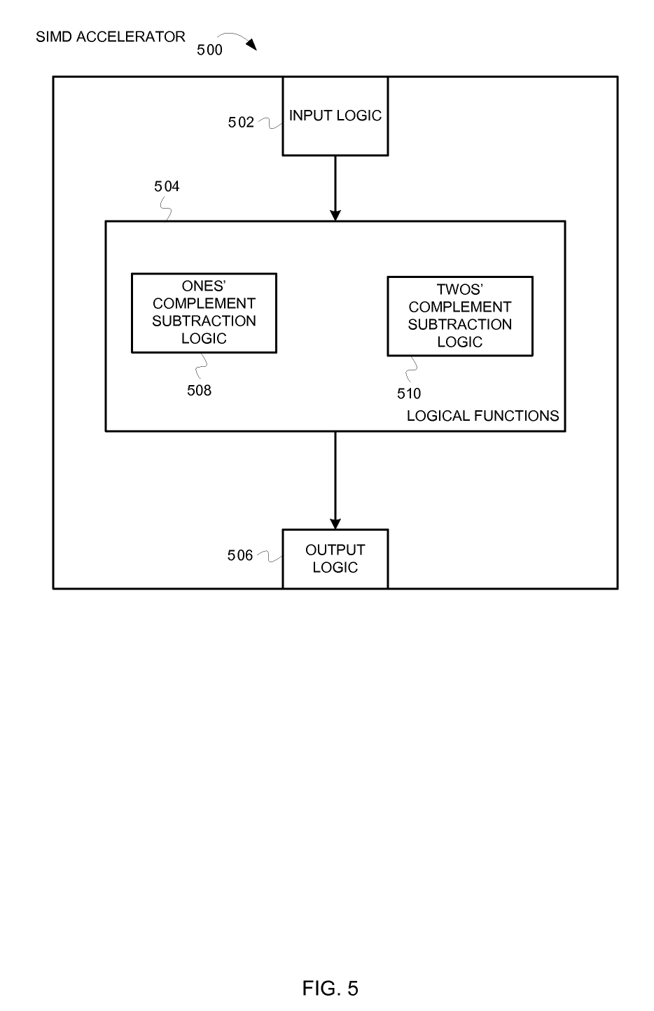

FIG. 5 depicts a more detailed block diagram of a SIMD accelerator that comprises logical function reuse, according to some example embodiments. In particular, FIG. 5 depicts a SIMD accelerator 500 that can be representative of any of the SIMD accelerators 100, 200, 300, and 400. The SIMD accelerator 500 includes an input logic 502, logical functions 504, and an output logic 506. The logical functions 504 include a ones' complement subtraction logic 508 and a twos' complement subtraction logic 510. The input logic 502 can receive the first and second operands (Operand A and Operand B) for processing. The logical functions 504 (including the ones' complement subtraction logic 508 and the twos' complement subtraction logic 510) perform the operations as described above in reference to FIGS. 2-4) to perform comparison of bytes, half-words, words, etc. of Operand A and Operand B. The output logic 506 is configured to output the result of this comparison. For example, the output logic 506 can return the result back to a process that issued the instruction to perform the comparison.

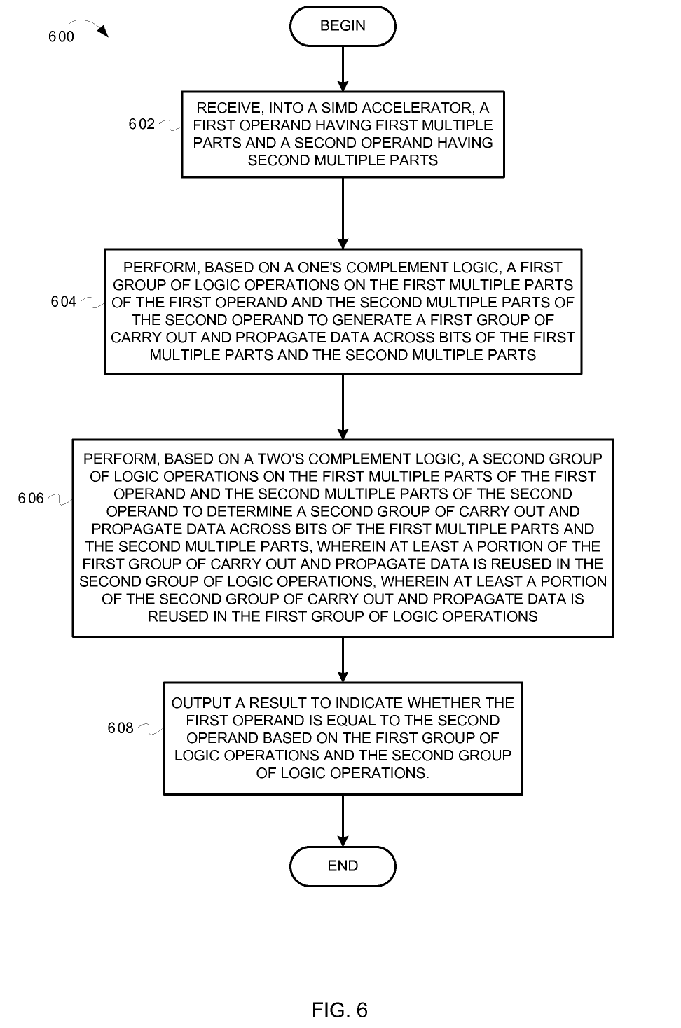

FIG. 6 depicts a flowchart of operations for byte comparison of two operands by a SIMD accelerator, according to some example embodiments. Operations of a flowchart 600 start at block 602.

At block 602, a SIMD accelerator receives a first operand having first multiple parts and a second operand having second multiple parts. For example, the first operand and the second operand can comprise multiple bytes, half-words, words, etc. (as described above). Operations of the flowchart 600 continue at block 604.

At block 604, the SIMD accelerator performs, based on a one's complement logic, a first group of logic operations on the first multiple parts of the first operand and the second multiple parts of the second operand to generate a first group of carry out and propagate data across bits of the first multiple parts and the second multiple parts. For example, the SIMD accelerator can perform the logical functions described in reference to FIG. 2, 3 or 4. Operations of the flowchart 600 continue at block 606.

At block 606, the SIMD accelerator performs, based on a two's complement logic, a second group of logic operations on the first multiple parts of the first operand and the second multiple parts of the second operand to determine a second group of carry out and propagate data across bits of the first multiple parts and the second multiple parts. At least a portion of the first group of carry out and propagate data is reused in the second group of logic operations. Also, at least a portion of the second group of carry out and propagate data is reused in the first group of logic operations. For example, the SIMD accelerator can perform the logical functions described in reference to FIG. 2, 3 or 4. Operations of the flowchart 600 continue at block 608.

At block 608, the SIMD accelerator outputs a result to indicate whether the first operand is equal to the second operand based on the first group of logic operations and the second group of logic operations. As described above, this result can be based on multiple byte, half-word, word, etc. comparisons across each of the two operands. Operations of the flowchart 600 are complete.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While the embodiments are described with reference to various implementations and exploitations, it will be understood that these embodiments are illustrative and that the scope of the inventive subject matter is not limited to them. In general, techniques for operand comparison as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. An apparatus for comparing a first operand to a second operand comprising:
a Single Instruction, Multiple Data (SIMD) accelerator configured to compare first multiple parts of first operand to second multiple parts of the second operand, the SIMD accelerator comprising,
an input logic configured to input the first operand and the second operand;
a ones' complement subtraction logic configured to perform a first group of logic operations on the first multiple parts of the first operand and the second multiple parts of the second operand to generate a first group of carry out and propagate data across bits of the first multiple parts and the second multiple parts;
a twos' complement subtraction logic configured to perform a second group of logic operations on the first multiple parts of the first operand and the second multiple parts of the second operand to determine a second group of carry out and propagate data across bits of the first multiple parts and the second multiple parts, wherein at least a portion of the first group of carry out and propagate data is reused in the second group of logic operations, wherein at least a portion of the second group of carry out and propagate data is reused in the first group of logic operations; and
an output logic configured to output a result to indicate whether the first operand is equal to the second operand based on the first group of logic operations and the second group of logic operations.

2. The apparatus of claim 1, wherein the first multiple parts comprises a first set of multiple bytes and the second multiple parts comprises a second set of multiple bytes, wherein the first group of logic operations and the second group of logic operations are performed between each byte of the first set of multiple bytes and each of the second set of multiple bytes, wherein the result is to indicate that the first operand is equal to the second operand, in response to aligned bytes of the first operand and the second operand being equal based on the first group of logic operations and the second group of logic operations.

3. The apparatus of claim 1, wherein the first multiple parts comprises a first set of multiple half-words and the second multiple parts comprises a second set of multiple half-words, wherein the first group of logic operations and the second group of logic operations are performed between each half-word of the first set of multiple half-words and each half-word of the second set of multiple half-words, wherein the result is to indicate that the first operand is equal to the second operand, in response to aligned half-words of the first operand and the second operand being equal based on the first group of logic operations and the second group of logic operations.

4. The apparatus of claim 1, wherein the output logic is configured to determine whether the first operand is greater than the second operand based on the first group of logic operations configured to be performed by the ones' complement subtraction logic.

5. The apparatus of claim 4, wherein the output logic is configured to determine whether the first operand is greater than the second operand based on the first group of carry out and propagate data.

6. The apparatus of claim 4, wherein the output logic is configured to determine whether the first operand is less than the second operand based on the second group of logic operations configured to be performed by the twos' complement subtraction logic.

7. The apparatus of claim 6, wherein the output logic is configured to determine whether the first operand is less than the second operand based on the second group of carry out and propagate data.

8. A system for comparing a first operand to a second operand comprising:
a machine-readable medium configured to store the first operand and the second operand;
a processor;
a Single Instruction, Multiple Data (SIMD) accelerator coupled to the machine-readable medium and the processor, wherein the SIMD accelerator is configured to retrieve and compare the first operand to the second operand in response to a communication from the processor to perform the compare, wherein the SIMD accelerator is configured to compare first multiple parts of first operand to second multiple parts of the second operand, the SIMD accelerator comprising,
a input logic configured to input the first operand and the second operand;
a ones' complement subtraction logic configured to perform a first group of logic operations on the first multiple parts of the first operand and the second multiple parts of the second operand to generate a first group of carry out and propagate data across bits of the first multiple parts and the second multiple parts;
a twos' complement subtraction logic configured to perform a second group of logic operations on the first multiple parts of the first operand and the second multiple parts of the second operand to determine a second group of carry out and propagate data across bits of the first multiple parts and the second multiple parts, wherein at least a portion of the first group of carry out and propagate data is reused in the second group of logic operations, wherein at least a portion of the second group of carry out and propagate data is reused in the first group of logic operations; and
an output logic configured to output a result to indicate whether the first operand is equal to the second operand based on the first group of logic operations and the second group of logic operations.

9. The system of claim 8, wherein the first multiple parts comprises a first set of multiple bytes and the second multiple parts comprises a second set of multiple bytes, wherein the first group of logic operations and the second group of logic operations are performed between each byte of the first set of multiple bytes and each of the second set of multiple bytes, wherein the result is to indicate that the first operand is equal to the second operand, in response to aligned bytes of the first operand and the second operand being equal based on the first group of logic operations and the second group of logic operations.

10. The system of claim 8, wherein the first multiple parts comprises a first set of multiple half-words and the second multiple parts comprises a second set of multiple half-words, wherein the first group of logic operations and the second group of logic operations are performed between each half-word of the first set of multiple half-words and each half-word of the second set of multiple half-words, wherein the result is to indicate that the first operand is equal to the second operand, in response to aligned half-words of the first operand and the second operand being equal based on the first group of logic operations and the second group of logic operations.

11. The system of claim 8, wherein the output logic is configured to determine whether the first operand is greater than the second operand based on the first group of logic operations configured to be performed by the ones' complement subtraction logic.

12. The system of claim 11, wherein the output logic is configured to determine whether the first operand is greater than the second operand based on the first group of carry out and propagate data.

13. The system of claim 11, wherein the output logic is configured to determine whether the first operand is less than the second operand based on the second group of logic operations configured to be performed by the twos' complement subtraction logic.

14. The system of claim 8, wherein the output logic is configured to determine whether the first operand is less than the second operand based on the second group of carry out and propagate data.

15. A method for comparing a first operand to a second operand, the method comprising:
receiving, into a Single Instruction, Multiple Data (SIMD) accelerator, a first operand having first multiple parts and a second operand having second multiple parts;
performing, based on a ones' complement subtraction logic, a first group of logic operations on the first multiple parts of the first operand and the second multiple parts of the second operand to generate a first group of carry out and propagate data across bits of the first multiple parts and the second multiple parts;
performing, based on a twos' complement subtraction logic, a second group of logic operations on the first multiple parts of the first operand and the second multiple parts of the second operand to determine a second group of carry out and propagate data across bits of the first multiple parts and the second multiple parts, wherein at least a portion of the first group of carry out and propagate data is reused in the second group of logic operations, wherein at least a portion of the second group of carry out and propagate data is reused in the first group of logic operations; and
outputting a result to indicate whether the first operand is equal to the second operand based on the first group of logic operations and the second group of logic operations.

16. The method of claim 15, wherein the first multiple parts comprises a first set of multiple bytes and the second multiple parts comprises a second set of multiple bytes, wherein the first group of logic operations and the second group of logic operations are performed between each byte of the first set of multiple bytes and each of the second set of multiple bytes, wherein the result is to indicate that the first operand is equal to the second operand, in response to aligned bytes of the first operand and the second operand being equal based on the first group of logic operations and the second group of logic operations.

17. The method of claim 15, where the outputting of the result comprises determining whether the first operand is greater than the second operand based on the first group of logic operations configured to be performed by the ones' complement subtraction logic.

18. The method of claim 17, where the outputting of the result comprises determining whether the first operand is greater than the second operand based on the first group of carry out and propagate data.

19. The method of claim 17, where the outputting of the result comprises determining whether the first operand is less than the second operand based on the second group of logic operations configured to be performed by the twos' complement subtraction logic.

20. The method of claim 19, where the outputting of the result comprises determining whether the first operand is less than the second operand based on the second group of carry out and propagate data.
